(19) United States
(12) Patent Application Publication
(10) Pub. No.: US 2006/0259200 A1
(43) Pub. Date: Nov. 16, 2006

(54) Hybrid generation system and control method thereof

(75) Inventors: Chang Min Choi, Seoul (KR); Yeong Seop Choe, Buchun-si (KR); Won Jae Choi, Seoul (KR); Jae Won Lee, Seoul (KR); Baik Young Chung, Inchun-si (KR); Se Dong Chang, Kwangmyung-si (KR)

Correspondence Address: GREENBLUM & BERNSTEIN, P.L.C., 1950 ROLAND CLARKE PLACE, RESTON, VA, 20191, US

(73) Assignee: LG Electronics Inc., Seoul (KR)

(21) Appl. No.: 11/432,513

(22) Filed: May 12, 2006

(30) Foreign Application Priority Data
May 14, 2005 (KR) 2005-40396

(51) Int. Cl. H02P 9/00; H02J 13/00

(52) U.S. Cl. 700/287

(57) ABSTRACT

The present invention relates to a hybrid generation system and a control method thereof. The hybrid generation system can maximize operation efficiency of a generator by selectively supplying normal utility power or power, which is generated by the generator, based on a power level supplied to a load. A hybrid generation system includes a generator and a generator controller. The generator generates power, and the generator controller performs a control activity to supply one of the normal utility power and the generated power to the load. The selective supply of the normal utility power or the generated power can maximize efficiency of the generator and as a result, a power consumption level of the hybrid generation system can be decreased, thereby reducing related costs.

### BACKGROUND OF THE INVENTION

1. Field of the Invention

The present invention relates to a hybrid generation system and a control method thereof, and more particularly, to a hybrid generation system, which supplies selectively one of normal utility power and power, which is produced by a generator, to a load depending on a level of power supplied to the load, and to a control method thereof.

2. Description of the Background Art

Driving power is generally required to drive home or industrial electrical appliances and devices. Typically, these home or industrial electrical appliances and devices receive necessary power through a power supply, which supplies normal utility power provided from a power station (e.g., Korea Electric Power Corporation). However, it is a frequent case that externally provided normal utility power is insufficient to supply power to all loads in industrial plants. Thus, a self-generation system is often prepared separately.

FIG. 1 is a configuration diagram illustrating a conventional self-generation system.

As illustrated, the self-generation system includes a generator 2, a switch 3 and a generator controller 4. The generator 2 generates power as an internal engine is driven and supplies the power to a load 1. The generator controller 4 sends data to the generator 2 or receives data from the generator 2 to control operation of the generator 2. The switch 3 is turned on or off in response to a control signal transmitted from the generator controller 4 to supply to the load 1 or break the power generated by the generator 2.

In the above conventional self-generation system, when a signal that indicates a load generation is transmitted to the generator controller 4, the generator controller 4 detects the signal, and generates a driving instruction and transmits the driving instruction to an engine of the generator 2. The generator 2 generates a certain level of power as the engine drives, and then, the switch 3 is turned on. As a result, the generated power is supplied to the load 1.

However, in the above described conventional self-generation system, the generator 2 is mandated to operate whenever there is a load generation. Hence, the generator 2 generates a certain level of power regardless of a size of the load and supplies the power to the load 1. Supplying the power to the load 1 may cause an abrupt decrease in efficiency of the self-generation system. For instance, assuming that a generator has the maximum operation efficiency when generating 100 kilowatts (KW) of power, the generator drives until reaching a state that the generator can generate 100 KW of power even if not only 100 KW of power but also 10 KW thereof are to be transferred to a load coupled with the generator. Accordingly, the self-generation system may have a decreased level of efficiency, and resources may be wasted unnecessarily and a cost to drive the generator may increase to a greater extent.

### SUMMARY OF THE INVENTION

Accordingly, an object of the present invention is to solve at least the problems and disadvantages of the background art.

It is an object of the present invention to provide a hybrid generation system, which can drive a generator effectively by determining operation efficiency of the generator based on a summated level of power supplied to a load and supplying normal utility power instead of power generated by the generator when the operation efficiency is low, and a control method thereof.

According to a first embodiment of the present invention, a hybrid generation system includes a generator engine and a generator controller. The generator generates a certain output to generate power. The generator controller summates a power level supplied to a load and selectively supplies normal utility power or the generated power according to the summated power level.

According to a second embodiment of the present invention, a method of controlling a hybrid generation system includes supplying power generated by a generator to a load and calculating a summated power level of the generated power supplied to the load and comparing the calculation result with an operation efficiency of the generator to supply one of the generated power and normal utility power to the load according to the comparison result.

### BRIEF DESCRIPTION OF THE DRAWINGS

The invention will be described in detail with reference to the following drawings in which like numerals refer to like elements.

FIG. 1 is a configuration diagram illustrating a conventional self-generation system;

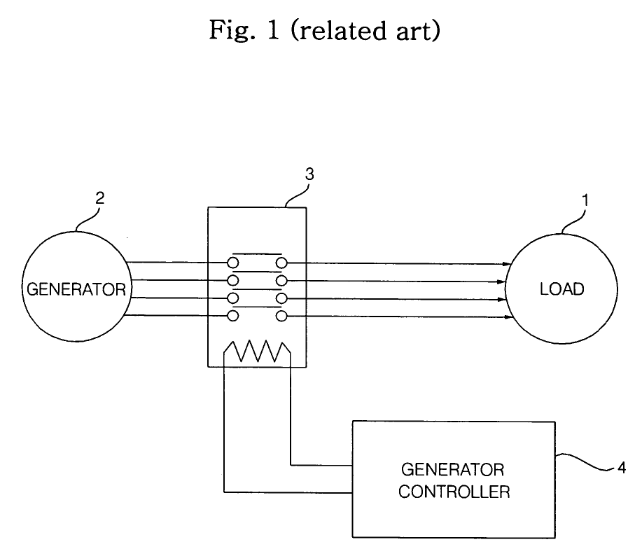

FIG. 2 is a block diagram illustrating a hybrid generation system according to an embodiment of the present invention;

FIG. 3 is a detailed configuration diagram illustrating the hybrid generation system according to the embodiment of the present invention; and

FIG. 4 is a flowchart illustrating a control method of the hybrid generation system according to another embodiment of the present invention.

### DETAILED DESCRIPTION OF PREFERRED EMBODIMENTS

Embodiments of the present invention will be described in a more detailed manner with reference to the drawings.

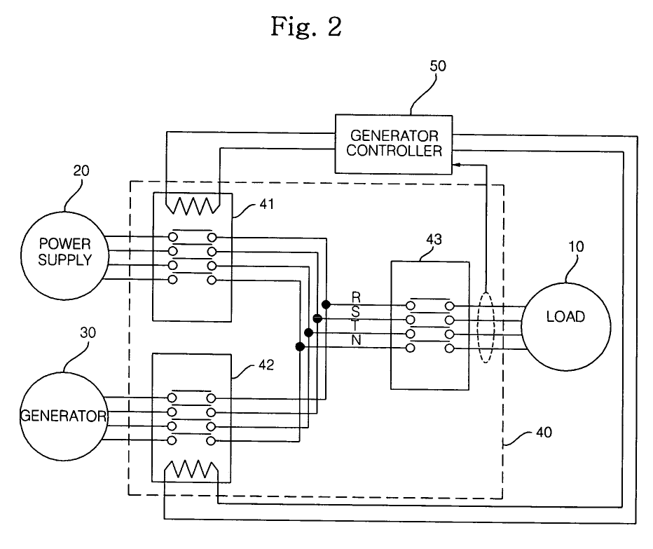

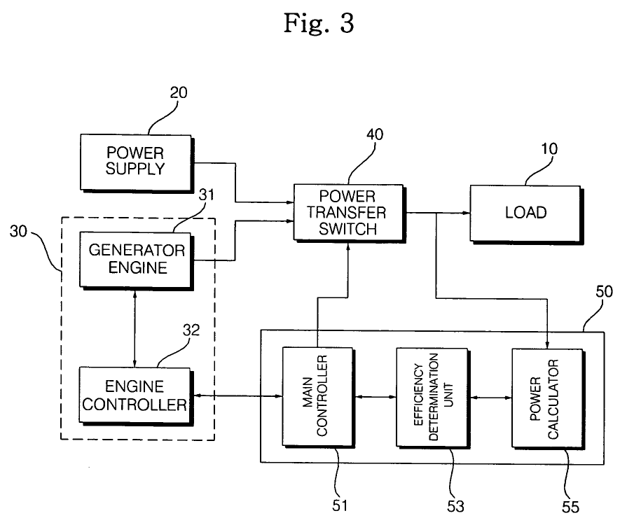

FIG. 2 is a block diagram illustrating overall configuration of a hybrid generation system according to an embodiment of the present invention. FIG. 3 is a detailed configuration diagram illustrating the hybrid generation system according to the embodiment of the present invention.

Referring to FIG. 2, the hybrid generation system includes a generator 30, a power transfer switch 40 and a generator controller 50. The generator 30 drives to generate power without an aid, and outputs the self-generated power. The generator controller 40 controls the generator 30 or a power supply 20 supplying normal utility power to make one of the generator 30 and the power supply 20 selectively supply power to a load 10 depending on a level of generated load. The power transfer switch 40 transfers one of power generated by the generator 30 and normal utility power provided from the power supply 20 to the load 10 in response to a control signal transmitted from the generator controller 50.

The power transfer switch 40 is coupled individually with the generator 30 and the power supply 20 and includes first and second switches 41 and 42, which can break driving power in response to a signal transmitted from the generator controller 50, and a circuit breaker 43, which can break the driving power transmitted through the first and second switches 41 and 42.

The first and second switches 41 and 42 may be configured as a magnetic relay switch, which is turned on or off according to the control signal transmitted from the generator controller 50. The circuit breaker 43 is a manual switch, and can prevent leakage current by shutting down the power supply when a level of power supplied to the load 10 through the first and second switches 41 and 42 exceeds a predetermined level.

In the present embodiment, an air conditioner is exemplified as the load 10 because the air conditioner generally consumes power with the maximum amount of load during summer and thus, frequently determines a peak level of power. However, it should be noted that the load 10 is not limited only to the exemplified air conditioner; rather, the load 10 can be configured with multiple devices that can drive by supplied power.

A self-generation system including the generator 30 can be configured to a cogeneration system. A cogeneration system uses waste heat while generating power using a co-generator and, includes an engine, a co-generator, which generates power using a rotational force produced by the engine, a heat supplier, which supplies waste heat collected from cooling water which cools the engine or an exhausted gas from the engine to a heat consumer such as an air conditioner.

The power generated in the cogeneration system can be used to operate various electrical appliances and devices such as light bulbs and air conditioners. Also, the cogeneration system may be specifically set to generate a consistent level of power under an optimum operation condition regardless of a size of the load generally necessary for such electrical appliances and devices such as air conditioners.

Referring to FIG. 3, in the case of the cogeneration system, the generator 30 includes a generator engine 31 and an engine controller 32. The generator engine 31 drives a generator 30, and the engine controller 32 controls whether to drive the engine 31 or controls a round per minute (RPM) value. Therefore, the generator controller 50 transmits a control signal to the engine controller 32 in response to a load generation for the purpose of increasing or decreasing a RPM value of the generator engine 31. As a result, a generation level of power by the generator 30 can be increased or decreased.

Particularly, the generator controller 50 includes a power calculator 55, an efficiency determination unit 53 and a main controller 51 to supply selectively one of power generated in the generator 30 and normal utility power provided from the power supply 20 to the load 10. The power calculator 55 summates a level of power transferred to the load 10. The efficiency determination unit 53 compares the summated level of power calculated by the power calculator 55 with operation efficiency of the generator engine 31 and determines the comparison result thereafter. According to the determination result by the efficiency determination unit 53, the main controller 51 generates a control signal and transmits the control signal to the power transfer switch 40.

Although not illustrated, the generator controller 50 further includes a memory into which a control program for operation of the main controller 51 and a data about the summated power level calculated by the power calculator 55.

The power calculator 55 detects and summates a level of power supplied from the circuit breaker 43 to the load 10.

In the case that the generated power by the generator 30 is supplied to the load 10, if the efficiency determination unit 53 determines that a summated level of power for a certain period falls within a range of low efficiency of the generator engine 31, the main controller 51 transmits an off-signal and an on-signal to the second switch 42 coupled with the generator 30 and to the first switch 41 coupled with the power supply 20, respectively. Also, the main controller 51 breaks a supply of the generated power and, supplies the normal utility power to the load 10.

In the case that the normal utility power is supplied to the load 10, if the efficiency determination unit 53 determines that a summated level of power for a certain period falls within a range of high efficiency of the generator engine 31, an off-signal and an on-signal are transmitted respectively to the first switch 41, which is coupled with the power supply 20, and the second switch 42, which is coupled with the generator 30. As a result, the power generated in the generator 30 is supplied to the load 10.

The efficiency determination unit 53 compares the summated level of the power with a generator efficiency based on the summated level. Various efficiency comparison methods may be employed depending on cases. For instance, a cost for the generator 30 to generate the summated power level supplied to the load 10 can be compared with a power rate charged based on the calculation for which the power is supplied from the power supply 20. That is, if the generation cost is higher than the power rate, the efficiency determination unit 53 may determine that the generator 30 is in a range of low efficiency. On the other hand, if the generation cost is lower than the power rate, the efficiency determination unit 53 may determine that the generator 30 is in a range of high efficiency.

More simply, on the basis of the maximum efficiency of the generator 30, if the summated power level exceeds approximately 50% of the power level generated by the generator 30, it may be determined that the generator 30 has high efficiency. On the other hand, if the summated power level does not exceed approximately 50% thereof, it may be determined that the generator 30 has low efficiency.

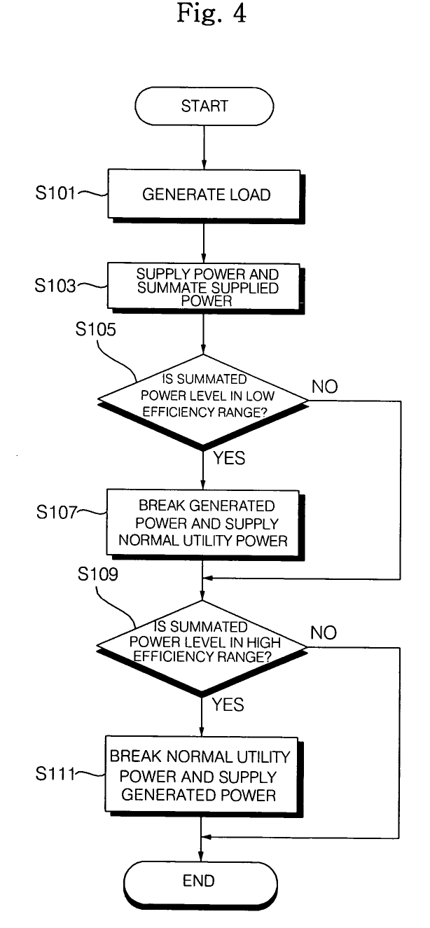

FIG. 4 is a flowchart illustrating a control method of the hybrid generation system according to another embodiment of the present invention. With reference to FIGS. 2 to 4, the other embodiment on the control method of the hybrid generation system will be described in detail.

When a load is generated in operation S101, the load generation is detected to drive the generator 30. In operation S103, when the generator 30 generates a certain output (e.g., electric power), a control signal is transmitted to the second switch 42 coupled with the generator 30, so that the power generated in the generator 30 is supplied to the load 10. Continuously, a level of the power transmitted to the load 10 is detected to calculate a summated power level.

After a certain elapse of time, in operation S105, operation efficiency of the generator 30 is determined based on a summated power level for the certain time elapse. At this point, the determination is based on a comparison result between a cost to generate the summated power level and a power rate charged according to a consumption level of the summated power level, or a reference value of approximately 50% of the generated power level in the generator 30.

If the determination result provided in operation S105 is that the operation efficiency of the generator 30 to generate the summated power level is low, in operation S107, the second switch 42 coupled with the generator 30 is broken, whereas the first switch 41 coupled with the power supply 20 is connected, so that normal utility power is supplied to the load 10.

If the normal utility power is supplied to the load 10 for a certain period of time, in operation S109, a summated power level calculated for the certain period of time and operation efficiency of the generator 30 are determined. If the determination result is that the generator 30 has high operation efficiency, in operation S111, the first switch 41 coupled with the power supply 20 is broken; on the contrary, the second switch 42 coupled with the generator 30 is connected. Hence, the generated power in the generator 30 is supplied to the load 10.

The generator 30 may be set to be detected by a user through outputting supply power (e.g., generated power or normal utility power) supplied to the load 10 and a data about a supply level of power to outside.

According to the exemplary embodiments of the present invention, using a summated level of power supplied to the load allows a determination of high or low operation efficiency of the generator. Thus, normal utility power and the generated power in the generator are set to be supplied selectively to the load. As a result, operation efficiency of the generator can be maximized, and the maximized operation efficiency results in a decreased level of power consumption in the hybrid generation system.

The invention being thus described, it will be obvious that the same may be varied in many ways. Such variations are not to be regarded as a departure from the spirit and scope of the invention and all such modifications as would be obvious to one skilled in the art are intended to be included within the scope of the following claims.

What is claimed is:

1. A hybrid generation system comprising:
a generator generating a certain output to generate power; and
a generator controller executing a control activity such that one of normal utility power provided by a power supply and the power generated by the generator is supplied to a load depending on a power level supplied to the load.

2. The hybrid generation system as claimed in claim 1, further comprising a power transfer switch breaking a transfer of the generated power or the normal utility power to the load in response to the control activity of the generator controller.

3. The hybrid generation system as claimed in claim 2, wherein the power transfer switch includes:
a first electrical switch and a second electrical switch making an individual coupling with the power supply and the generator and turned on and off in response to the control activity of the generator; and
a circuit breaker breaking a power supply activity when power transmitted through the first and second electrical switches exceeds a predetermined level.

4. The hybrid generation system as claimed in claim 1, wherein the power level is a summated power level calculated by summing a power level supplied to the load.

5. The hybrid generation system as claimed in claim 1, wherein the generator includes:
a generator engine generating power; and
an engine controller controlling operation of the generator engine in response to the control activity of the generator controller.

6. The hybrid generation system as claimed in claim 5, wherein the generator controller includes:
a power calculator detecting a power level transferred to the load and summating the transferred power level;
an efficiency determination unit comparing the summated power level calculated by the power calculator with operation efficiency of the generator engine and determining the comparison result; and
a main controller controlling the power transfer switch according to the determination result by the efficiency determination unit.

7. The hybrid generation system as claimed in claim 6, wherein when the generated power is supplied to the load, the main controller performs a control activity to break a supply of the generated power and supply the normal utility power if the efficiency determination unit determines that the summated power level falls within a range of low efficiency of the generator engine.

8. The hybrid generation system as claimed in claim 7, wherein the efficiency determination unit determines that the generator falls in the range of the low efficiency when operation efficiency of the generator with respect to the power level supplied to the load does not exceed approximately 50%.

9. The hybrid generation system as claimed 6, wherein when the normal utility power is supplied to the load, the main controller performs a control activity to break a supply of the normal utility power and supply the generated power if the efficiency determination unit determines that the summated power level falls within a range of high efficiency of the generator engine.

10. The hybrid generation system as claimed 9, wherein when the generator generates the power level supplied the load, the efficiency determination unit determines that the generator falls within the range of the high efficiency if a cost to consume the power level is higher than a cost to consume the normal utility power.

11. A method of controlling a hybrid generation system comprising:
supplying power generated by a generator to a load; and
calculating a summated power level of the generated power supplied to the load and comparing the calculation result with an operation efficiency of the generator to supply one of the generated power and normal utility power provided by a power supply according to the comparison result.

12. The method as claimed in claim 11, wherein at the calculating of the summated power level of the generated power and the comparing of the calculation result with the operation efficiency of the generator, if efficiency of the generator to generate the summated power level is determined to be low, a supply of the generated power is broken and the normal utility power is supplied.

13. The method as claimed in claim 12, wherein at the calculating of the summated power level of the generated power and the comparing of the calculation result with the operation efficiency of the generator, if the operation efficiency of the generator with respect to the power level supplied to the load is less than approximately 50%, efficiency of the generator is determined to be low.

14. The method as claimed in claim 11, further comprising breaking the normal utility power and supplying the generated power if efficiency of the generator to generate a power level of the power supply is determined to be high when the normal utility power is supplied to the load.

15. The method as claimed in claim 14, wherein at the supplying of the generated power, when the generator generates the power level supplied to the load, efficiency of the generator is determined to be high if a cost to consume the power level is higher than a cost to consume the normal utility power.
